(19) United States
(12) Patent Application Publication
(10) Pub. No.: US 2023/0366126 A1
(43) Pub. Date: Nov. 16, 2023

(54) APPARATUS AND METHOD OF ORIFICE INSPECTION AND CARBON DIOXIDE CLEANING THEREOF

(71) Applicant: Gerald Henrici, New York, NY (US)

(72) Inventor: Gerald Henrici, New York, NY (US)

(21) Appl. No.: 18/142,117

(22) Filed: May 2, 2023

Related U.S. Application Data
(60) Provisional application No. 63/340,112, filed on May 10, 2022.

(51) Int. Cl. D01D 4/04; B24C 1/00; B24C 3/32; B24C 5/04; B08B 7/00; B08B 13/00

(52) U.S. Cl. CPC D01D 4/04; B24C 1/003; B24C 3/325; B24C 5/04; B08B 7/0021; B08B 13/00

(57) ABSTRACT

The present invention relates to a process and apparatus to inspect and clean orifices found on extrusion dies, spinnerets and other objects having small holes. Orifices are microscope imaged and digitally measured, and if required the invention performs non-contact orifice cleaning using carbon dioxide dry ice particles.

This patent application claims priority to, and fully incorporates by reference herein, U.S. provisional patent application No. 63/340,112, filed on May 10, 2022, entitled SPINNERET CO₂ CLEANING APPARATUS AND METHOD, as if fully set forth herein.

### FIELD OF THE INVENTION

The present invention relates to a method and apparatus for the inspection and cleaning of small holes and orifices.

### BACKGROUND OF THE INVENTION

Extrusion dies also known in the art as spinnerets, are used in the polymer extrusion process for manufacturing filaments. Popular polymers include polyester, polyethylene, rayon, nylon etc. . . . . Spinnerets are precision tools with one or more orifices or holes through which a polymer is forced in order to produce filaments that are then drawn and formed into yarn and other products by the chemical fiber industry in a process referred to as spinning. Spinnerets are typically round and have an outside diameter of less than 10 to more than 1,500 mm or, if rectangular in shape, less than 10 to more than 8,000 mm long by less than 5 to more than 500 mm wide. They range from less than 0.5 to more than 100 mm thick and may have from 1 to more than 100,000 orifices. Orifice exit-openings range from less than 0.030 to more than 8.0 mm in diameter. Orifice exit shapes are round or complex such as trilobal, octalobal, slot, dog bone, and other shapes. These common exit shapes have very small and hard to clean features.

During the spinning process the spinneret builds up on its exit surface a variety of different oxidized polymer materials and additives that eventually foul the spinneret, causing it to be removed from the spinning process. Before the spinneret can be re-used in the production process it must be cleaned to remove all of the contaminants.

Dirt is a colloquial term used to refer to all unwanted residue and contaminants that may be left on the spinneret and its orifices after it has been taken out of service and initially cleaned. Loose dirt such as airborne fibers and dust can settle on the spinneret surface and orifices, as well as hand skin and oil paste from fingers, can partially occlude orifices. Loose dirt ordinarily does not create a spinning production problem as it is easily expelled by the flow of polymer. Compressed air can remove some but not all of the loose dirt. Another type of contaminant is “hard dirt.” Hard dirt, which is not easily removed, include polymer residues, carbon, ash, and additives such as TiO₂. In addition, glass beads used in fluidized bed ovens can become lodged in the small legs of complex orifice exits. These contaminants can be easily found with microscope inspection, but hard dirt is very difficult to clean due to its strong surface adhesion to orifice capillary features. All of the spinneret's orifices must be substantially free of any hard dirt before being returned to the production process. If they are not, then the extruded product produced will likely be defective.

Another problem that can mimic hard dirt is physical damage to the orifice. Scraping and other hand tools used during spinning or handling can damage the spinneret by scratching and pushing surface metal into the orifice or nicking the orifice's exit. Additionally, post-inspection cleaning while attempting to remove the hard dirt with specialized tools can itself, create new orifice damage. There is a higher chance of creating new damage while cleaning small orifices compared to large orifices. This type of damage appears as hard dirt but cannot be cleaned. When this type of problem is found the spinneret must be taken out of service and then repaired or discarded.

In many extruded products, the uniformity of all of the filaments produced from a spinneret is a requirement of the product and any non-uniform filaments are considered to be defective. It is well known that filament uniformity is primarily controlled by having an equal flow of polymer through every orifice of the spinneret. However, if an individual orifice, is fully or partially occluded by hard dirt, that orifice's maximum diameter, profile and effective cross section area is reduced. This in turn reduces the flow of polymer through that orifice compared to other clean orifices in that spinneret which in turn results in a defective product. In addition, other typical production problems resulting from un-clean orifices may include slow holes, stoppages, and doglegging leading to drips. These types of problems can result in the spinneret having to be removed prematurely from the spinning process leading to higher production costs and increased environmental waste.

Conventional devices and methods have attempted to effectively clean spinnerets and spinneret orifices. U.S. Pat. No. 3,188,239 to Kloppers et al. discloses treatment of the spinneret in a molten salt bath. U.S. Pat. No. 5,011,541 to Leech discloses cleaning spinnerets using a high-pressure water jet. U.S. Pat. No. 5,728,226 to Buckingham relates to a process for cleaning an assembled spin pack of a melt spinning assembly utilizing supercritical fluids. JP2010196189A utilizes air cleaning, not CO₂. The foregoing references are fully incorporated into this document as if fully set forth herein.

Conventional methods for initial primary cleaning of the entire spinneret include cleaning ovens and fluidized bed systems with or without inert gas or vacuum chambers, molten salt baths, Triethylene glycol or other solvents typically followed by an ultrasonic cavitation bath and high-pressure water jet cleaning.

These methods are used to clean the complete spinneret, but none of them can reliably remove all unwanted material from small orifice features. Consequently, non-contact visual inspection of the spinneret's orifices is used to find specific orifices that have failed to be completely cleaned.

According to the existing art, if an inspection of a spinneret shows that the spinneret has been poorly cleaned, resulting in many failed orifices, then it may be more practical to send the spinneret back for complete re-cleaning. However, if the number of orifice failures do not warrant a full re-cleaning, then the systems operator will attempt secondary individual orifice fine cleaning using specialized tools such as metallic cleaning needles, broaches, shim stock or soft metal wire inserted into the spinneret orifice to dislodge the unwanted material. These secondary cleaning methods are based on mechanical contact between the tool and the orifice and can easily cause the delicate features of the orifice being cleaned to be damaged by the tool or its operator.

Thus, there exists a need for an effective secondary orifice cleaning process that is mechanically non-contact, non-destructive, non-abrasive, environmentally friendly, and without chemical waste.

### SUMMARY OF THE INVENTION

In an embodiment, the present invention is directed to an apparatus and method for the inspection of spinneret orifices, and other small orifices, and CO₂ dry ice particle cleaning of orifices.

After a spinneret is removed from production, it is run through an initial primary cleaning process that attempts to remove all of the unwanted polymer and additive residue. Cleaning success is related to the size of the features being cleaned. Very small orifice features are difficult to clean and require post cleaning inspection to ensure that they have been successfully cleaned.

Automatic inspection is performed using a motor-driven positioning table, an optical microscope in conjunction with illumination, a camera, and a system controller to measure the microscope image.

If the inspection process finds an orifice that has not been fully cleaned, then the device can perform secondary cleaning by moving the orifice from under the microscope, to position it under the CO₂ cleaning nozzle. The system then discharges CO₂ through the nozzle creating a focused stream of supersonic CO₂ dry ice particles. The impact of these particles substantially dislodges all the remaining un-cleaned material. The system can then re-inspect the orifice to evaluate the success of the cleaning and can repeat the cleaning cycle if required. Once all of the un-cleaned orifices have been re-cleaned and now pass inspection, the spinneret can be returned back for re-use in production.

In addition to spinnerets, the present invention can also be used to inspect and clean a wide variety of perforated objects that have small orifices such as hydro-entanglement jet strips, spray tips, and wire extrusion dies.

### BRIEF DESCRIPTION OF THE DRAWINGS

FIG. 1 is a schematic plan showing a device for carrying out the overall process of the invention.

FIG. 2A shows a perspective view looking up into the inspection and cleaning apparatus

FIG. 2B shows a perspective view looking down at the inspection and cleaning apparatus.

FIG. 3A is a perspective view of a round spinneret that describes orifice locations.

FIG. 3B is a side view of the spinneret.

FIG. 3C is a section view showing two orifices.

FIG. 3D is a detail view of an orifice.

FIG. 3E shows examples of different orifice capillary exit shapes showing both round and complex capillaries.

### DETAILED DESCRIPTION OF THE INVENTION

The process and apparatus of the present invention is suited to the inspection and CO₂ cleaning of orifices. More particularly, the invention concerns the detection of orifice occlusion, determination of the need to clean the orifice, and the cleaning of the orifice with carbon dioxide (“CO₂”) dry ice particles, prior to re-using the spinneret in the filament production process.

The inventor of the present invention is the developer and maker of a line of automated spinneret inspection systems known as SpinTrak™. Automated spinneret inspection systems (“ASIS”), such as SpinTrak™, are designed to inspect the orifices of extrusion dies used in yarn, staple, spunbond, and meltblown applications and other objects having small holes. ASIS utilize digital image processing technology to measure orifice geometry. ASIS are designed to find orifices that have not been successfully cleaned or have been damaged due to use or poor handling.

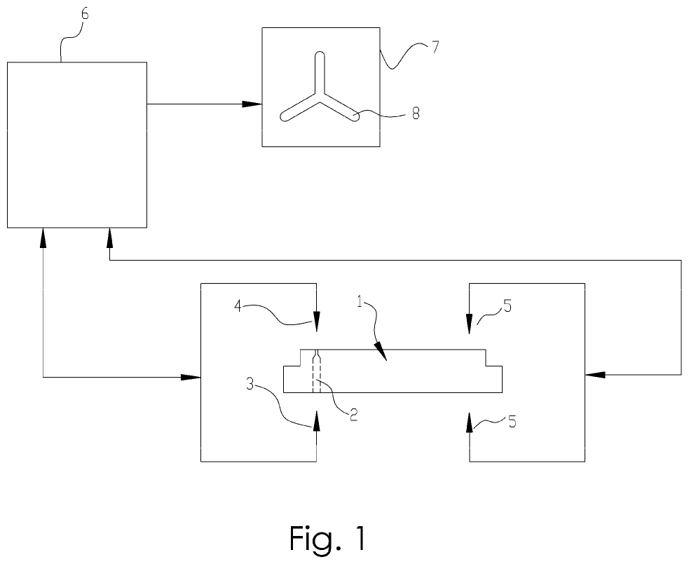

FIG. 1 shows a schematic diagram of the invention. In operation an initially cleaned but un-inspected spinneret is placed on the ASIS table. This spinneret, approximately 100 mm in diameter, had been previously used in the spinning process but due to fouling had to be taken out of production and initially cleaned. The table is equipped with an X, Y, & Z coordinate linear positioning system that allows each orifice in the spinneret to be positioned for inspection and then if required positioned to allow secondary CO₂ cleaning. A side view of the spinneret 1 shows the hidden cross section of a common orifice design 2. A backlight 3 is positioned to pass light through the orifice in the same pathway as normal polymer flow. An optical microscope assembly 4 acquires the resultant digital image. The systems computer-based controller 6 stores a list of valid spinneret types to be inspected and cleaned. For each spinneret, information is stored such as overall spinneret shape and size, number of orifices, shape and size of each orifice exit, pass/fail measurement limit criteria and other inspection directives.

In the system controller the microscopes image is measured and then compared to a pre-defined pass/fail criteria to determine if excessive dirt or exit shape damage is present. The system controller also provides keyboard and mouse input for the operator to work with the software to select the type of spinneret to be inspected and to start the inspection. It also controls the positioning table, dry air valve, CO₂ valve, block heater and front and backlight intensity adjustment and other devices as needed.

When a failure is found, the system controller moves the failed orifice under the CO₂ cleaner 5 where one or more cleaners may be used for top and bottom cleaning. The valve is then activated to shoot CO₂ onto the top and/or bottom surfaces and the interior surfaces of the orifice. After re-cleaning, the orifice is then moved again under the microscope assembly and re-inspected to determine if it is sufficiently clean. If it is not, then the process can be repeated. Once the spinneret is clean it can be reassembled with the rest of the filter pack components and the pack can be put back into service. A display monitor 7 allows the operator to use the ASIS software and to display a live or computer processed microscope image 8.

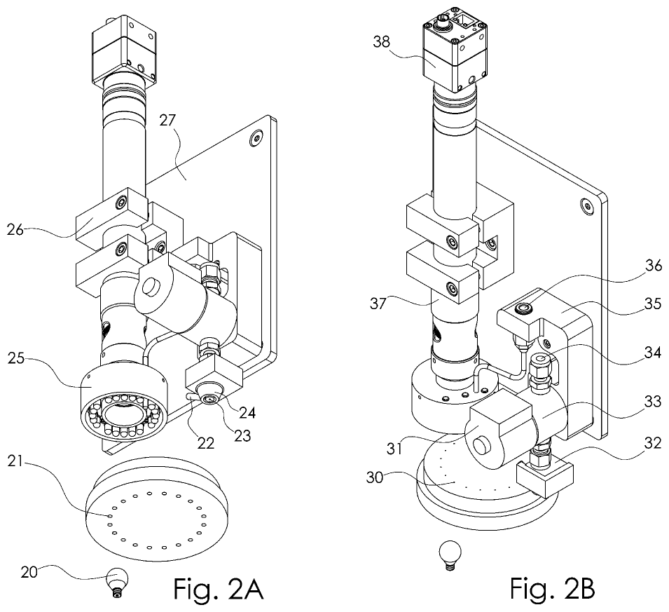

FIGS. 2A and 2B show perspective views looking up (FIG. 2A) and down (FIG. 2B) into the inspection and cleaning apparatus. 21 points to the spinnerets large counterbore entrance to the orifice. This is where polymer enters the orifice. Typical counterbores range from 2 to 4 mm in diameter. A backlight 20 is positioned under the spinneret to pass light through the orifice in the same pathway as the polymer flow. Inspection of the orifice capillary and capillary exit normally uses backlight illumination to detect un-cleaned material as this direction of light most closely approximates the path of polymer. A plate 27 is provided to mount both the inspection and cleaning devices. Attached to this plate is a microscope clamp 26 that holds an optical microscope 37. This plate also holds a support block 35 used to hold components of the cleaning system. Attached to the microscope is a camera 38. The camera image is sent to the system controller where it is analyzed using digital image processing algorithms to measure the orifice. Measurements made of the orifice's microscope camera image are compared to previously established measurement criteria to determine if an orifice is considered clean. A front ring light 25 illuminates the spinneret's capillary exit side. This front light is used for measuring polymer wear of the orifice's exit geometry and can also be used by the ASIS operator to visually see if any surface scratches, gouges or dents have damaged the orifice's capillary. This type of surface damage can result from poor spinneret handling or hand tool damage. When a dirty orifice is found, the system controller (FIG. 1 at 6) activates the positioning system to move the spinneret's failed orifice under the CO₂ cleaning device. A block heater 32 is attached to the CO₂ nozzle 23. The heater heats the nozzle to approximately 80 C (176 F). As the pressurized CO₂ flows through the heated nozzle it is converted to a super critical state (sCO2). A source of dry air enters the shroud at port 22. This continuous stream of dry air fills the shroud 24 and then flows out of the shroud opening and/or enveloping the CO₂ nozzle in a moving column of air. This column of dry air displaces the humid ambient room air, preventing the formation of water droplets. A source of CO₂ enters at port 34 and is controlled by a solenoid valve. The valve is electrically operated and is comprised of a valve body 33 and valve coil 31. When actuated, it is desirable for this valve to produce well defined bursts of CO₂ having a fast on and off time. To achieve this the valve is connected directly to the CO₂ nozzle. In addition, there is a port for dry air 36 that leads to an air tube. If desired, the system controller can blow air to attempt the cleaning of loose dirt.

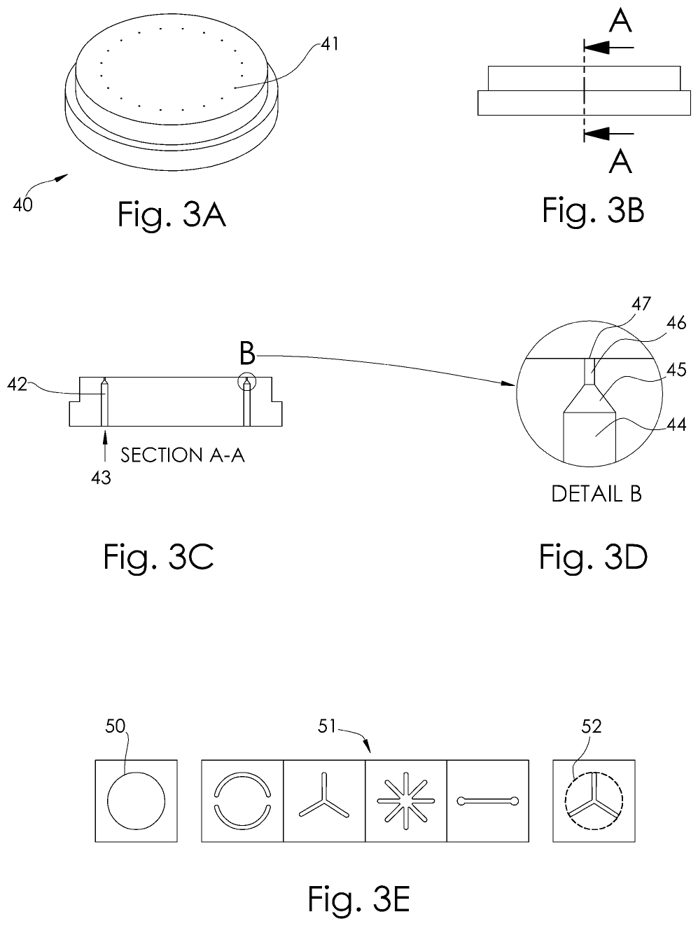

FIG. 3A shows a perspective view of a type of spinneret 40 commonly used in the production of polyester yarn. The spinneret is 100 mm in diameter. View 41 shows a ring of 20 orifices on the polymer exit side of the spinneret. FIG. 3B shows a side view of the spinneret showing section cut A-A. FIG. 3C is a sectional view A-A of the spinneret that shows two of the orifices. The direction of polymer flow is indicated in 43. A detail circle “B” is also shown. FIG. 3D shows the enlarged detail “B” showing the counterbore 44, transition structure 45, capillary 46 and the capillary's exit 47. Pre-inspection cleaning of the large counterbore and transition features is very successful compared to the very small capillary and capillary exit features. The capillary and capillary exit are very small and are especially difficult to safely clean without causing damage.

FIG. 3E is a top view showing microscope views of orifice capillary exit shapes both round and complex. Round capillaries 50 are the most common with typical exit diameters ranging from 0.100 to 0.300 mm. A small sample of different complex capillaries shapes is shown in 51. These exit shapes are comprised of straight or arching narrow slots that commonly range in width from 0.030 to 0.100 mm. If an enclosing circle represented by a dotted line, is drawn around a complex exit shape 52, the circles diameter will typically be from 0.500 to 1.5 mm in size.

The present invention has achieved a useful integration of an ASIS with a CO₂ cleaning assembly that removes un-cleaned dirt from an orifice that would otherwise need to be dislodged mechanically and cleaned by the ASIS operator. Using a combination of ASIS inspection and a focused CO₂ dry ice particle jet assembly for cleaning, provides superior cleaning requiring less labor by the technician. ASIS plus the CO₂ cleaning process of the invention achieves an all-in-one non-contact inspection and cleaning system.

The cleaning system consists of a CO₂ source, a filter, an on/off valve, and PTFE lined flexible hosing to transport the CO₂ from its source to the nozzle. To be of practical use, it is desirable for the cleaner assembly to produce on demand, efficiently generated supersonic velocity CO₂ dry ice particles from a gas or liquid feed source. Nozzles of various types may be used ranging from a simple straight pipe to more advanced designs. It has been found that CO₂ nozzles of an asymmetric venturi (convergent—divergent) design are the best suited to this application. While other CO₂ nozzle designs can be used, this design is the most efficient at quickly producing large amounts of CO₂ ice particles from a gas or liquid feed source. CO₂ dry ice particles are produced in the asymmetric venturi nozzle by the controlled expansion of CO₂. This expansion leads to the nucleation of small dry ice particles that move at supersonic velocities. Upon impact with the surface of the spinneret, the particles remove dirt of all sizes by momentum transfer, and hydrocarbons and organics via a transient solvent or a freeze-fracture mechanism. The high-velocity jet of CO₂ ice particles carries the dislodged contaminants away. The CO₂ ice particle cleaning process of the invention removes orifice contaminants of all sizes, from visible down to 3-5 nanometers See Carbon Dioxide Snow Cleaning, Co2clean, www.co2clean.com, at FN 2010. Also, hydrocarbon-based and organic residues that are part of spinning production can be removed.

If cleaning is found to be necessary following an inspection, the orifice is moved under the CO₂ cleaner. When the jet of CO₂ particles hits the orifice, its temperature drops rapidly. This can cause water droplets to form inside of the orifice's capillary. The droplets are formed from condensing water vapor in the ambient air. Condensation in the orifice makes re-inspection of the orifice nearly impossible and it also makes further cleaning difficult as it blocks the CO₂ stream from hitting the desired locations. To reduce this effect an air shroud was designed such that it surrounds the CO₂ nozzle. This shroud is filled by a source of dry instrument air that lowers the chance of condensation droplets forming following a blast. This dry air is run continuously during the cleaning cycle and is warmed by the block heater. In between blasts, the warm dry air raises the temperature of the orifice area so that each subsequent blast can induce a further thermal shock, increasing its cleaning effectiveness. Also, if any condensation does form, then the continuous stream of air helps to dry the orifice in a fast and effective manner.

By experimentation it has been observed that cleaning is most effective if used in multiple short blasts that are 12 to 50 ms in duration. The repeated thermal shocks that result from multi-blast sequences, makes it more effective at removing dirt. Very short blasts of 10 ms or less can also be used to remove water droplets. It has also been found that varying the distance between the CO₂ nozzle jet and the spinneret can improve cleaning efficiency. In this process the first blast starts approximately 50 mm distance from the orifice. Over a sequence of 3-8 blasts and moves, the CO₂ cleaner assembly nozzle is incrementally lowered so that the last blast is approximately 10 mm away from the spinneret surface.

The asymmetric venturi nozzle is designed to produce a narrow needle shaped jet of CO₂ dry ice particles. For cleaning, the jet is typically positioned directly over the center of the capillary exit. In most cases the CO₂ jet diameter is larger than the capillary exit diameter resulting in complete cleaning coverage of the capillary exit by the CO₂ jet. However, in the case of large round or complex capillary exits, it is possible for the CO₂ to provide only partial coverage from one fixed over the center position.

The system controller's software contains a predefined list of spinnerets that can be inspected. When a spinneret containing large capillaries is selected by the ASIS operator, the system controller can determine if complete capillary cleaning coverage is possible. If the capillary is too large to clean from one fixed position, the system controller, based on the inspection measurement results can identify the specific location(s) within the exit where dirt has been found and cleaning is required. The system controller then automatically directs the positioning of the CO2 nozzle to clean those locations. Alternatively, another mode of operation is to pre-define a fixed cleaning movement pattern for each type of capillary exit shape and then perform cleaning by following that pattern. Cleaning within the capillary exit can increase cleaning efficiency.

It has also been determined that providing the CO₂ nozzle with a source of super critical carbon dioxide (sCO₂) further improves cleaning efficiency. Supercritical carbon dioxide (sCO₂) is a state of carbon dioxide where it is held at or above its critical temperature and critical pressure. More specifically, it behaves as a supercritical fluid above its critical temperature (31.10° C., 87.98° F.) and critical pressure (7.39 MPa, 1,071 psi), expanding to fill its container like a gas but with a density like that of a liquid. The sCO₂ will release more energy upon contact with the dirt if it is supercritical. We achieve sCO₂ by heating the nozzle to 80 C with a block heater under PID control. The CO₂ reaches 1,400 PSI at 80 C inside the nozzle and a supercritical state is achieved.

1. An apparatus for inspecting and cleaning a spinneret or other object comprising small holes or orifices having obstructive material, comprising:
a hole inspection device, and
a hole cleaning device for cleaning out said obstructive material with CO₂.

2. The apparatus of claim 1 wherein said obstructive material further comprises dirt.

3. The apparatus of claim 1 wherein the spinneret or other small hole object further comprises holes having a enclosing circle diameter from less than 0.030 to more than 8.0 millimeters.

4. The apparatus of claim 1 wherein the CO₂ device further comprises a nozzle for delivering CO₂.

5. The apparatus of claim 4 wherein the nozzle further comprises a valve.

6. The apparatus of claim 1 wherein the hole cleaning device further comprises a CO₂ source, a filter, a valve, and nozzle.

7. The apparatus of claim 4 wherein the nozzle delivers CO₂ at supersonic velocity.

8. The apparatus of claim 4 wherein the nozzle delivers CO₂ in one or multiple bursts.

9. The apparatus of claim 4 wherein said nozzle comprises a venturi nozzle.

10. The apparatus of claim 5 wherein the valve is a solenoid valve.

11. The apparatus of claim 6 where the CO₂ pathway distance between nozzle and the valve body is less than 350 mm.

12. The apparatus of claim 1 wherein said CO₂ is super critical CO₂.

13. The apparatus of claim 1 wherein said hole inspection device comprises an automated spinneret inspection system.

14. The apparatus of claim 1 wherein the apparatus further comprises a system controller that further comprises a predetermined number of spinneret types.

15. The apparatus of claim 1 wherein the apparatus further comprises a system controller.

16. The apparatus of claim 1 wherein said apparatus further comprises an air shroud.

17. The apparatus of claim 1 wherein said apparatus further comprises a heater.

18. An apparatus for the inspection and cleaning of an orifice, comprising:
one or more light sources for illuminating the orifice;
a controller for positioning the orifice under said one or more light sources for inspection;
a microscope for visually enhancing and displaying the orifice;
a camera for use in conjunction with said microscope for capturing an image of the orifice;
a CO₂ cleaning device.

19. The apparatus of claim 18 wherein the CO₂ cleaning device further comprises a nozzle.

20. The apparatus of claim 18 wherein the CO₂ cleaning device delivers CO₂ at supersonic velocity.

21. The apparatus of claim 18 wherein said CO₂ cleaning device delivers super critical CO₂.

22. The apparatus of claim 18 wherein the CO₂ cleaning device comprises a venturi nozzle.

23. The apparatus of claim 18 wherein the CO₂ cleaning device further comprises an air shroud or chamber.

24. A method for inspecting and cleaning a spinneret or other object containing small holes comprising:
providing an orifice inspection device;
inspecting said holes for obstructive material with said inspection device;
providing a CO₂ cleaning device and said inspection device,
removing said obstructive material with CO₂.

25. The method of claim 24 wherein the CO₂ cleaning device emits CO₂ in one or multiple blasts.

26. The method of claim 24 wherein the CO₂ cleaning device delivers super critical CO₂.

27. The method of claim 24 wherein the CO₂ cleaning device is protected by an air shroud or chamber.

28. The method of claim 24 wherein the CO₂ cleaning device further comprises a nozzle.

29. The method of claim 28 wherein the nozzle is an asymmetric venturi nozzle.

30. The method of claim 24 wherein the CO₂ cleaning device delivers CO₂ at supersonic velocity.
